(19) United States
(12) Patent Application Publication
(10) Pub. No.: US 2003/0188186 A1
(43) Pub. Date: Oct. 2, 2003

(54) System and method for authorizing printing services

(76) Inventors: Darrel D. Cherry, Boise, ID (US); James Clough, Boise, ID (US); David L. Smith, Eagle, ID (US)

Correspondence Address: HEWLETT-PACKARD COMPANY, Intellectual Property Administration, P.O. Box 272400, Fort Collins, CO, 80527-2400, US

(21) Appl. No.: 10/117,144

(22) Filed: Apr. 1, 2002

(51) Int. Cl. H04L 9/00

(52) U.S. Cl. 713/200

(57) ABSTRACT

A system and method for proper authorization of printing services is described. The system and method secures access to printing services in a public communication network. A print job request is received through the network and an attempt is made to ascertain the source for the print job. If the source is ascertained, then a determination is made whether the source for the print job originated from within the network or outside the network, prior to authorizing the printing of the print job. If the print job originates from within the network, printing of the print job is authorized.

### TECHNICAL FIELD

The present invention is related to printer services in a public environment.

### BACKGROUND

In a typical public communication network center, multiple authorized users (or clients) may have access to a communication network. One challenge for the centers is to protect the integrity of their printing equipment from unauthorized use. Public communication network centers run a security risk of tampering or unauthorized access to printers, if they are unable to authenticate print jobs submitted on their network. Additionally, a user may gain access to printing services that the user is not entitled, if printer authentication is insecure. Examples of printing services that a communication network center may desire to secure include: setting page limits for print jobs, permitting color printing, permitting photo quality printing, charging fees for printing quantities and/or qualities, providing particular access to a particular printer per user, and other related printing services.

Another challenge for public networked printing centers is the ability to authenticate print jobs when they are received via a virtual private network (VPN) or related Internet technique. Authorized users on a public intranet network may submit print jobs to printers located on the public network through their VPN. To the public intranet network, however, this print job may appear to have no relation to the authorized user, since it ultimately is received by the network through the Internet.

### SUMMARY

A system and method for proper authorization of printing services is described. The system and method secures access to printing services in a public communication network. In a described implementation, a print job request is received through a network and an attempt is made to ascertain the source for the print job. If the source is ascertained, then a determination is made whether the source for the print job originated from within the network or outside the network, prior to authorizing the printing of the print job. If the print job originated from within the network, printing of the print job is authorized.

### BRIEF DESCRIPTION OF THE DRAWINGS

The detailed description is described with reference to the accompanying figures. In the figures, the left-most digit(s) of a reference number identifies the figure in which the reference number first appears.

FIG. 1 illustrates an exemplary public communication system with printing service capability.

FIG. 2 illustrates an exemplary hotel public communications system.

FIG. 3 is a flow chart illustrating a process for authorizing printing services.

FIG. 4 illustrates a print job with source indicia from the device that rendered the print job.

FIG. 5 shows a history of recorded network traffic database.

FIGS. 6A and 6B are flow charts illustrating a more secure process for authorizing printing services than described in FIG. 3.

FIG. 7 illustrates random exemplary code associated with a unique authorization code.

### DETAILED DESCRIPTION

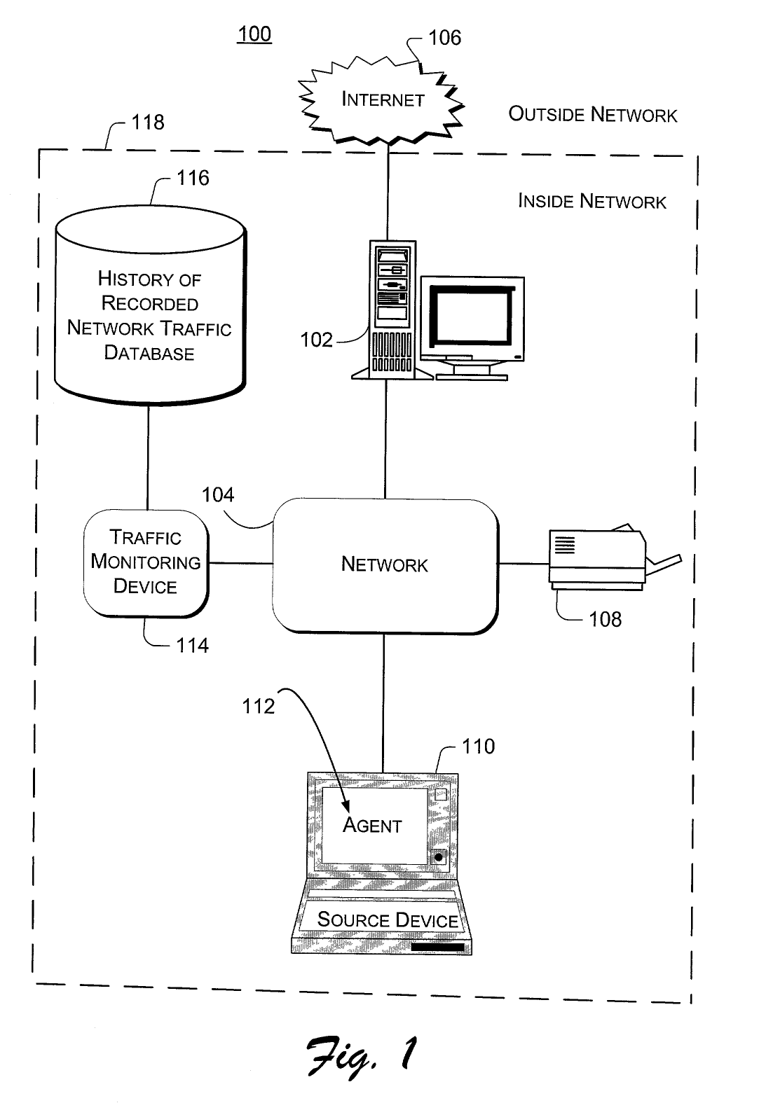

FIG. 1 illustrates an exemplary public communication system 100 with printing service capability. As a public communication system 100, system 100 is typically implemented as a public intranet service to one or more users. A hotel, business center, airport travel center, Internet café, copier center are illustrations of the type of public communication systems 100 that may desire to authorize printing services, prior to permitting a print job to be processed. System 100 includes a server 102, a network 104, an Internet portal site 106 connected to server 102, a printer 108, a source device 110, an agent 112, a traffic monitoring device 114 and a history of recorded network traffic database 116. System 100 may include a plurality of the any of the aforementioned devices.

Server 102 monitors print requests on system 100. That is, server 102 verifies whether print jobs submitted by source device 110 are authorized. Server 102 may be implemented as any type of security monitoring device such as a shared computer, a print request computer, or as a software application running on a host device, such as a computer.

Network 104 serves as a communications channel between devices connected to it. That is, print jobs submitted to a printer 108 use network 104 as path for transferring information. Network 104 may be implemented as a network (local and wide area, etc.), a switch, a bus (such as a shared Ethernet bus), or other related means to provide wired or wireless communication between devices.

Internet portal site 106 serves as an optional gateway to the Internet for devices associated with system 100. Most public communication systems 100 provide access to and from the Internet, including the ability for a source device 110 to send a print job from an offsite enterprise host (not shown) to a local printer 108 in proximity to source device 110. The connection between source device 110 and the offsite enterprise host may be accomplished through a VPN, Hyper Text Transfer Protocol (HTTP), HTTP Secure (HTTPS) and other related protocol communications between source device 110 and an offsite enterprise host.

Printer 108 is any type of printing or other image forming device that may be used in system 100. As used herein, “printer,” “printer device” or the like, means any electronic device having data communications, data storage capabilities, and/or functions to render printed characters and images on a print media. A printer device may be a printer, fax machine, copier, plotter, and the like. The term “printer” includes any type of printing device using a transferred imaging medium, such as ejected ink, to create an image on print media. Examples of such a printer can include, but are not limited to, laser printers, inkjet printers, plotters, portable printing devices, as well as multifunction combination devices (MFB).

Source device 110 is a user operated device capable of sending a print job request. Source device 110 may be implemented as a portable electronic device, such as a portable digital assistant (PDA), a laptop computer, a wireless handset telephone and other related devices. Source device 110 may also be implemented more generally as a computer. As used herein “computer” means any electronic device or software running on a device that is capable of processing print data in some manner.

Agent 112 is typically implemented in some functional media such as software executing commands on behalf of server 102. Agent 112 further serves as an interface between network 104 and source device 110. In other words, agent 112 permits a source device 110 to gain access to network 104. In one implementation, agent 112 can be installed on the source device 110 during a log-on period to system 100. Accordingly, agent 112 can run on source device 110, such as in the back ground or as a HTML page that appears on the client's web browser (not shown). In other implementations, agent 112 could also be selected to run on a network, switch, server or related devices in communication with source device 110. Server 102 can request that the source device 110 load agent 112 as a requisite to gaining access to system's 100 intranet site. Prior to being installed on the source device 110, agent 112 typically resides on an internal hard disk drive (not shown) or portable media drive (not shown) in server 102, or other server related device connected to network 104. Examples of suitable portable storage media include DVD, floppy disks, CD-ROM, and so forth.

Traffic monitoring device 114 is any type of packet (including frames) switching multiplexing device capable monitoring transmitted data over the network 104. Exemplary implementations of a traffic monitoring device 114 include, but are not are not limited to, a switch, an Ethernet data switch, hub, routers and so forth. Typically, traffic monitoring device 114 is able to track a source and destination for each packet sent over network 104 and record all such information in a storage media, such as history of recorded network traffic database 116. Such a data base 116 can be resident within traffic monitoring device 114 or be accessible to traffic monitoring device 114/server 102. Database 116 in one implementation is cache for a switching device implemented as traffic monitoring device 114. Further, although traffic monitoring device 114 is shown as a separate device, it can be implemented to operate as part of a server 102 in certain implementations.

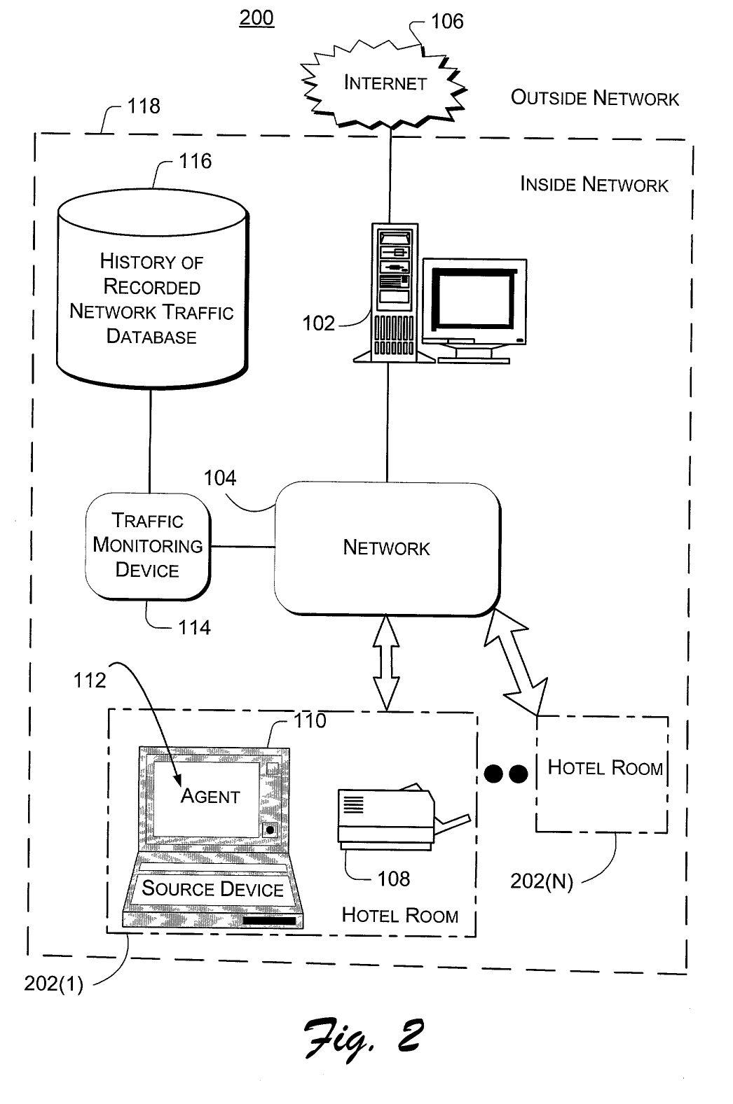

FIG. 2 illustrates an exemplary hotel public communications system 200. In this implementation, network 104 is implemented as a local area network bus 104 with broadband connectivity, such as cable or Ethernet. Accordingly, each hotel room 202(1)-202(N) is optionally equipped with broadband access ports, permitting a user to connect the source device 110 (such as a laptop computer) to the network 104. As shown in FIG. 2, each room 202 is optionally equipped with its own printer 108, permitting the user to have the convenience of printing locally. The source device 110 may also have the option of printing to other locations such as hotel room 202(N) or a front-desk printer (not shown).

As will be described in more detail, systems 100 and 200 are equipped with the operable capability to validate and authorize print jobs. Systems 100, 200 can be implemented to authorize or deny a print job based on whether the source of the print job originates from a device within network or a device residing outside the intra-network. For purposes of illustration, all devices connected to network 104 that are within the borders of dotted box 118 are representatively considered to reside “within the network.” On the hand, devices on other network domains, including those which reside on a site unrecognized by server 102 (such as any devices located on the Internet in this example), are considered to reside “outside the network” and box 118.

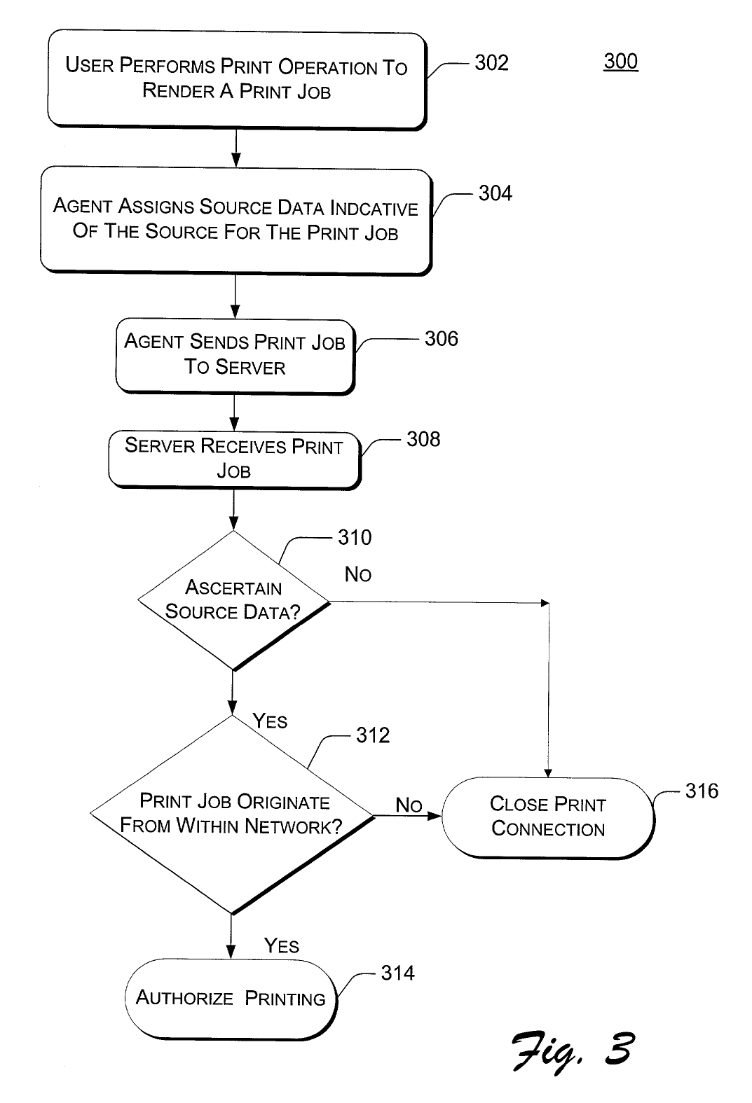

FIG. 3 is a flow chart illustrating a process 300 for authorizing print services in system 100, 200. Process 300 can be implemented in one or more computer-readable media (disks, memory, CD, DVD, etc.) with computer instructions that, when executed, perform the steps illustrated therein. Reference shall be made to FIGS. 1-3. Prior to performing process 300, a source device 110 logs-on to network 104. Source device 110 may log-on to network 104 through any standard client/server process. Source device 110 typically uses a web browser (not shown) to initiate sign-on communications with network related devices such as server 102.

An agent 112 in the form of a thread is sent from server 102 and loaded onto the source device 110. Agent 112 immediately communicates with server 102 using standard TCP/IP protocols. For convenience purposes, agent 112 is typically running in the background and is invisible to the user.

As shown in FIG. 3, in step 302, a user performs a print operation to render a print job via source device 110. Typically, a user will perform the print operation with standard off-the-shelf software applications via a Windows based, UNIX or other operating system printing application. For instance, a user selects the “File” icon and initiates a print operation via the “Print” icon. A print job is rendered with a driver (not shown) and sent to a spooler (not shown) and then a port monitor (not shown) all of which are standard items in most printing environments. Next, the port monitor sends the print job to agent 112 as a temporary file.

In step 304, agent 112 then obtains a source address or any data indicative of the identity of source device 110. For instance, in one implementation, agent 112 retrieves the Media Access Control (MAC) address. Agent then assigns (embeds) the source address and any and any other information needed to uniquely identify the source device 110, such as the room number 202(1), to the header of a print job.

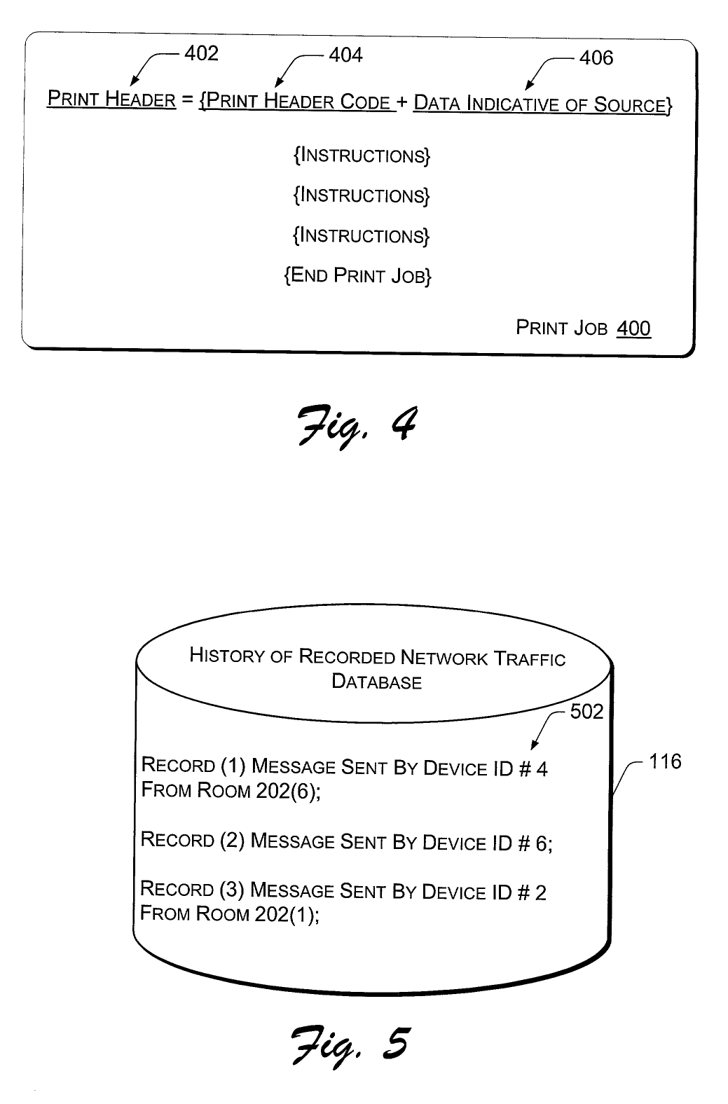

FIG. 4 represents one example of a rendered print job 400 with a printer header 402 containing code 404 plus data 406 indicative of the source device 110. In the exemplary implementation of FIG. 2, data 406 indicative of the source would include the source address of device 110 and the room number from which device 110 is connected to network 104. It is also possible to assign data 406 to other portions of print job 400.

Next, in step 306 agent 112 sends (i.e. broadcasts) print job 400 to server 102 including any print data which can be in raw, compressed, intermediate or other related formats. Typically, agent 112 sends the aforementioned data to server 102 via HTTP, HTTPS, FTP or other communication protocol.

Next, step 308 server 102 receives the print job 400. In a decisional step 310 server 102 ascertains whether print job 400 contains any data 406 that would indicate the source of the print job 400. If according to the “NO” branch of block 310, there is no such data 406, then server 102 does not allow print job 400 to be printed. In this scenario it is likely that the print job was received outside network 118 through Internet portal 106. The print job is not allowed according to step 316, because the source that sent the print job cannot be verified.

If according to the “YES” branch of decisional block 310, server 102 is able to ascertain data indicative of the source, such as the MAC address and/or room number 202(1), then server 102 checks whether the print job originated from within the intra-network (inside representative box 118), according to step 312.

In one implementation, server 102 searches a history 502 of network traffic recorded in database 116 to determine whether the source device 110 actually produced any traffic within a give time period (for example, within ten minutes of receiving the print job). If device 110 did send a print job to server 102, then database 116 should show that there was message sent from device 110 to server 102 within the past ten minutes.

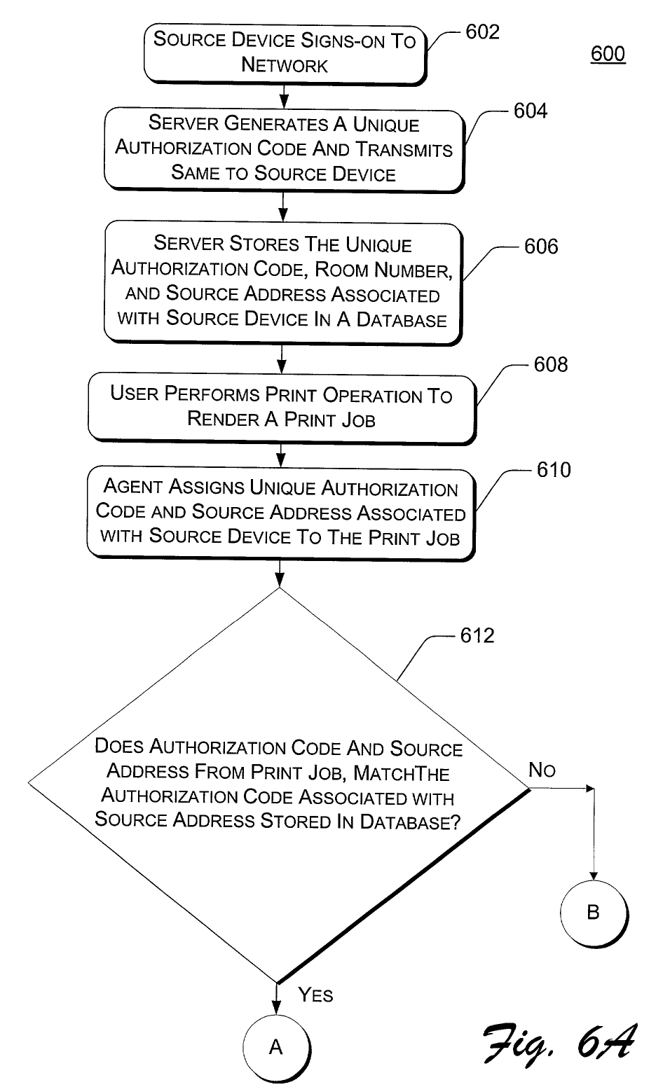

FIG. 5 shows a history of recorded network traffic database 116 with records 1-3 from cache associated with traffic monitoring device 114. If server 102 is able to search database 116 and locate a record with matching source address information, then according to the “YES” branch of step 312 server 102 authorizes print job 400 to be connected to printer 108 in room 202(1). For example, record (3) in FIG. 5, shows that a message was sent by device ID#2 from room 202(1). If the print job header 402 contains matching source data 406 as record (3), then server 102 has verified that print job 400 originated from within the network 118. On the other hand, if no record is located indicating that the print job was generated from a designated source located within the network, then according to “NO” branch of step 312, the print job is not authorized. Accordingly, the print job is not connected to the specified printer as shown in step 316.

In another implementation, server 102 may query traffic monitoring device 114 to verify whether the source device 110 that sent the print job 400 is actively connected to network 104 through an authorized port. If monitoring device 114 is able to verify that the source device that sent the print job is currently connected to network 104 through an authorized port, then the print job is authorized according to the “YES” branch of decisional block 312 and step 314. If monitoring device 114 is not able to establish that the source device is actively connected to the network 104 through the query, then printing is not authorized and the print connection is closed as shown in step 316.

In the case of a source device 110 VPNed back to their enterprise Intranet, server 102 will receive the print job 400 with the print job the data indicative of the originating source (device 110) embedded in the header 402. If server 102 is able to verify that source device 110 is currently connected to network 104 or produced traffic on the network recently (via the traffic history database 116), then the print job is considered to originate from within the intra-network 118, as described above, even though the print job 400 is received by server 102 via Internet port 106.

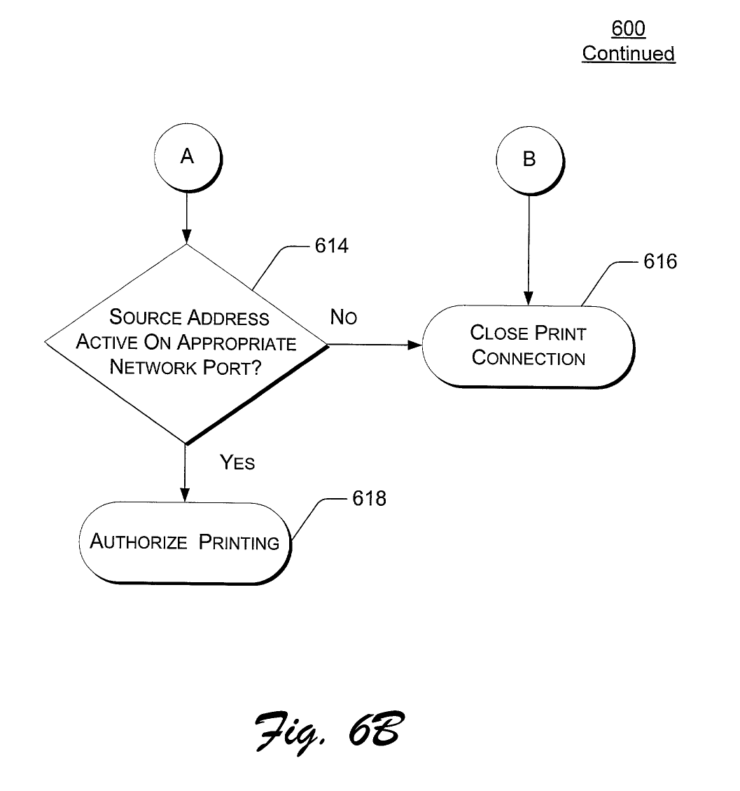

FIGS. 6A and 6B are flow charts illustrating a process 600 for authorizing printing in the hotel environment shown in FIG. 2. FIGS. 6A and 6B are conceptually similar to FIG. 3, except added security features are included as described below.

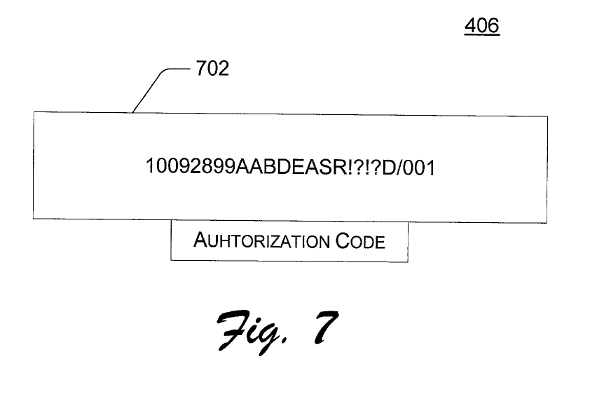

Process 600 includes steps 602-618. In step 602, when the source device 110 initially signs on to network 104, server 102 generates a unique authorization code 702 (as shown in FIG. 7) and transmits the code 702 to the source device 110. Authorization code 702 may be any string of characters that can be randomly generated by the server 102 or created based on other parameters, such as the location of the device, date, time, or other codes that would not be readily apparent to anyone except personnel associated with administering the network 104. To increase security, when the authorization is sent to the source device 110, it may be encrypted to prevent an unauthorized third party from obtaining the authorization code. As shall become apparent, this authorization code 702 can form at least a portion of the data indicative of the source 406 described above.

In step 606, server 102 associates the authorization code 702 to the particular source device 110 that received the code in step 602, by recording the authorization code 702, room number 202(1) (in the exemplary hotel implementation), and source address (e.g., the MAC address) of the source device 110 in a server accessible database.

Later, in steps 608 and 610, when the client performs a print operation rendering a print job 400, agent 112 attaches the authorization code 702 and source address associated with the source device 110 to the print job 400. In one implementation, this accomplished by placing the authorization code 702 as well as source address in a combined field (data indicative of source 406) of the print header 402. Accordingly, when the print job 400 is sent from the source device 110, it contains the authorization code 702 and source address of the device 110. To prevent a third party from gaining access to the authorization code, the print job 400 should also be encrypted.

In step 612, when the server 102 receives the print job 400, it verifies that the authorization code 702 matches the authorization code 702 associated with the source address previously stored in the database in step 606. If they do not match, then in step 616 (FIG. 6B), the server 102 does not print job to be connected to the printer 108.

On the other hand, if they do match, then in step 614, the server 102 checks the history of recorded network traffic database 116 to ascertain if the source address is active on the network 104 from the appropriate network port (e.g., room 202(1)). So, if a record 502 exists indicating that the same device, which sent the print job 400, also recently sent a message from the correct location on the network 104 (presumably the message was the print job 400), then the server 102 authorizes the connection of the print job 400 with printer 108. If no record 502 exists in the history of recorded network traffic database 116, which matches the appropriate network port or is recent enough, then the print job is not authorized by server 108 and the print connection is closed as shown in step 616.

Without an authorization code 702, an unauthorized third party (an attacker) could first determine the MAC address of an authorized host (for instance, server 102) and then send this MAC address with unauthorized print jobs. The server 102 would receive the MAC address, determine that it is within the network and has been transmitting recently, and accept the print job 400. With the authorization code, the print job 400 would not be accepted because the attacker would not be able to determine the correct authorization code for the MAC address, if any.

Without the use of a source address such as the MAC address of the source device 110, a once authorized user would be able to print after they check out of the hotel, or in a more general implementation, when the user loses access to the physical network 104.

Thus, although the present invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. In a network, a method comprising:
receiving a print job;
ascertaining a source for the print job; and
determining whether the source for the print job originated from within the network, prior to authorizing printing of the print job.

2. The method as recited in claim 1, wherein ascertaining the source for the print job comprises obtaining data from the print job indicative of the source.

3. The method as recited in claim 1, wherein determining whether the source for the print job originated within the network comprises: monitoring whether the source for the print job is connected to the network from within the network.

4. The method as recited in claim 1, wherein determining whether the source for the print job originated within the network comprises: storing network traffic in a database and searching the database to confirm that the source for the print job created at least a portion of the network traffic initiated from within the network.

5. The method as recited in claim 1, further comprising assigning data indicative of the source to the print job.

6. The method as recited in claim 1, further comprising not authorizing the printing of the print job, if the print job is determined to originate from outside the network.

7. The method as recited in claim 1, further comprising assigning an authorization code and source address to the print job.

8. One or more computer-readable media comprising computer-executable instructions that, when executed, perform the method of as recited in claim 1.

9. A method comprising:
receiving a print job broadcasted over a network;
checking whether there is data associated with the print job indicative of the source for the print job;
if the data exists, then searching a history of recorded network traffic for a record with matching data; and
if the record is located, then authorizing the printing of the print job.

10. The method as recited in claim 9, wherein the data is a source address of a device that broadcast the print job.

11. The method as recited in claim 9, wherein the data is a MAC address of a device that broadcast the print job.

12. The method as recited in claim 9, wherein the print job is received by a network monitoring device, prior to authorizing the print job.

13. The method as recited in claim 9, further comprises not authorizing the printing of the print job if no record with matching data is located in the history of recorded network traffic.

14. The method as recited in claim 9, further comprises not authorizing the printing of the print job if there is no data associated with the print job indicative of the source for the print job.

15. The method as recited in claim 9, further comprising embedding the data indicative of the source of the print job in a header of the print job.

16. One or more computer-readable media comprising computer-executable instructions that, when executed, perform the method as recited in claim 9.

17. A system comprising:
a monitoring device attached to a network, configured to record a source address of an electronic device that produces a message on the network; and
a security monitoring device, configured to (i) receive a print job broadcast over the network; (ii) ascertain a source address for the print job; and (iii) verify whether the source address of the print job matches the source address of the electronic device that produced the message on the network.

18. The system as recited in claim 17, wherein the security monitoring device is further configured to permit the print job to be connected to a printer if the source address of the print job matches the source address of the electronic device that produced the message on the network.

19. The system as recited in claim 17, further comprises a traffic history table, in signal communication with the monitoring device, configured to store the recorded source address.

20. The system as recited in claim 17, wherein the security monitoring device is a packet switching device.

21. The system as recited in claim 17, wherein the security monitoring device is a server.

22. The system as recited in claim 17, further comprising an agent operating on the electronic device configured to attach the source address of the electronic device to the print job.

23. The system as recited in claim 17, further comprising an agent operating on the electronic device configured to embed the source address of the electronic device to a header of the print job.

24. A method for proper authorization of printing services in a network, comprising:
assigning an authorization code to a computer;
storing the authorization code and source address for the computer in a database;
receiving a print job;
ascertaining whether the source address and authorization code for the print job matches the authorization code and source address for the computer stored in the database;
determining whether the computer is active on the network; and
authorizing printing of the print job if the authorization code and source address for the print job matches the authorization code and source address associated with the computer stored in the database and if the computer is active on the network.

25. The method as recited in claim 24, wherein the source address is the MAC address of the computer.

26. The method as recited in claim 24, wherein determining whether the computer is active on the network, comprises verifying whether recent traffic received over the network contains a source address that matches the computer.

27. The method as recited in claim 24, wherein determining whether the computer is active on the network, comprises querying the computer to determine that the computer is physically connected to a port on the network.

28. The method as recited in claim 24, further comprising assigning a room number to the computer and storing the room number in association with the source address and authorization code in the database.

29. The method as recited in claim 24, further comprising assigning a room number to the computer and storing the room number in association with the source address and authorization code in the database and authorizing printing of the print job if the authorization code, room number and source address for the print job matches the authorization code, room number and source address for the computer stored in the database and if the computer is active on the network.

30. The method as recited in claim 24, wherein the network is located in a hotel.

31. One or more computer-readable media comprising computer-executable instructions that, when executed, perform the method as recited in claim 24.
